(19) United States
(12) Patent Application Publication
(10) Pub. No.: US 2020/0153321 A1
(43) Pub. Date: May 14, 2020

(54) MOTOR CORE

(71) Applicant: TOYOTA JIDOSHA KABUSHIKI KAISHA, Toyota-shi (JP)

(72) Inventors: Hideki MANABE, Toyota-shi (JP); Shinya URATA, Nagakute-shi (JP); Yoshitaka MAEDA, Nagakute-shi (JP)

(21) Appl. No.: 16/653,680

(22) Filed: Oct. 15, 2019

(30) Foreign Application Priority Data
Nov. 14, 2018 (JP) 2018-213644

(51) Int. Cl. H02K 15/10; H02K 3/42

(52) U.S. Cl. CPC H02K 15/10; H02K 3/42

(57) ABSTRACT

A motor core that ensures reduction of eddy-current loss and improvement of a space factor at the same time is provided. The motor core according to the present disclosure includes a laminated body where a plurality of metal plates are laminated; a fixing member that fixes the plurality of metal plates to each other at a fixing position in a peripheral edge side of the laminated body; and an insulation film disposed between the metal plates in a peripheral edge portion of the laminated body including the fixing position. In a center portion of the laminated body, no insulation film is disposed between the metal plates, or an insulation film thinner than the insulation film in the peripheral edge portion is disposed between the metal plates.

### CROSS REFERENCE TO RELATED APPLICATIONS

The present application claims priority from Japanese patent application JP 2018-213644 filed on Nov. 14, 2018, the content of which is hereby incorporated by reference into this application.

### BACKGROUND

### Technical Field

The present disclosure relates to a motor core that includes a laminated body in which a plurality of metal plates are laminated.

### Background Art

Conventionally, for a motor core, a laminated body of metal plates is often used. In the laminated body, a plurality of metal plates, such as electromagnetic steel plates, are insulated from one another by insulators between the plates and laminated to reduce an eddy-current loss.

In the motor core where such a laminated body is used, it is required to reduce the eddy-current loss and, at the same time, it is required to improve a torque performance by increasing a space factor as a proportion of a volume occupied by the metal plates in the laminated body. While the eddy-current loss can be reduced by thinning the metal plate, the thinned metal plate increases a proportion of a volume occupied by an insulation film in the laminated body to decrease the space factor, thus the performance of the torque and the like is decreased.

When an amorphous alloy ribbon having an excellent magnetic property or a nanocrystalline alloy ribbon obtained by crystallizing the amorphous alloy ribbon is used for the metal plate, the metal plate is thin compared with the case where the electromagnetic steel plate is used. This is advantageous in reducing the eddy-current loss, but the space factor decreases and an influence of the decreased performance increases.

As a method for improving the performance while reducing the eddy-current loss, for example, like a core disclosed in JP 2017-92077 A, there has been known a core where the reduction of the eddy-current loss is ensured by actively disposing the insulation film between the metal plates to insulate the metal plates from one another and various ideas are applied to improve the performance. In addition, there has been known a core where the space factor is improved without the insulation film by insulating the metal plates from one another with the use of a void generated between the metal plates.

### SUMMARY

However, as the core disclosed in JP 2017-92077 A, in the core Where the insulation films are actively disposed between the metal plates to insulate the metal plates from one another, voids are generated between the metal plates in a region in its center side apart from fixing positions of the plurality of metal plates in its peripheral edge side of the laminated body, and this generates intervals between the metal plates by a sum of thicknesses of the insulation film and the void in some cases. Accordingly, the space factor possibly decreases. Especially, when the amorphous alloy ribbon or the nanocrystalline alloy ribbon described above is used for the metal plate, the decrease of the space factor is remarkable due to the decrease in thicknesses of the metal plate.

In the above-described core where the voids generated between the metal plates are used to insulate the metal plates from one another, at a peripheral edge portion of the laminated body close to fixing positions of the plurality of metal plates, the metal plates are mutually in close contact and fail to ensure sufficient insulation, thus the eddy-current loss cannot be reduced in some cases.

The present disclosure has been made in view of the above-described problems, and the present disclosure provides a motor core that ensures the reduction of eddy-current loss and the improvement of the space factor at the same time.

To solve the above-described problems, the motor core according to the present disclosure includes a laminated body where a plurality of metal plates are laminated; a fixing member that fixes the plurality of metal plates to each other at a fixing position in a peripheral edge side of the laminated body; and an insulation film disposed between the metal plates in a peripheral edge portion of the laminated body including the fixing position. In a center portion of the laminated body, no insulation film is disposed between the metal plates, or an insulation film thinner than the insulation film in the peripheral edge portion is disposed between the metal plates.

### EFFECT

The present disclosure ensures the reduction of the eddy-current loss and the improvement of the space factor at the same time.

### BRIEF DESCRIPTION OF THE DRAWINGS

FIG. 1 is a schematic perspective view illustrating an exemplary motor core according to a first embodiment;

FIG. 2A is a schematic cross-sectional view illustrating a cross section taken along the line A-A of FIG. 1;

FIG. 2B is an enlarged view of a part X of FIG. 2A;

FIG. 2C is an enlarged view of a part Y of FIG. 2A;

FIG. 3A is a schematic plan view illustrating a metal thin plate illustrated in FIGS. 2A to 2C;

FIG. 3B is a schematic plan view illustrating the metal thin plate and an insulation film illustrated in FIGS. 2A to 2C;

FIG. 4 is a photograph indicating an exemplary cross section taken along the line B-B of FIG. 1;

FIG. 5A is a schematic cross-sectional view illustrating an exemplary motor core according to a second embodiment corresponding to FIG. 2A;

FIG. 5B is an enlarged view of a part X of FIG. 5A; and

FIG. 5C is an enlarged view of a part Y of FIG. 5A.

### DETAILED DESCRIPTION OF THE EMBODIMENTS

A motor core according to the present disclosure includes a laminated body where a plurality of metal plates are laminated; a fixing member that fixes the plurality of metal plates to each other at a fixing position in a peripheral edge side of the laminated body; and an insulation film disposed between the metal plates in a peripheral edge portion of the laminated body including the fixing position. In a center portion of the laminated body, no insulation film is disposed between the metal plates, or an insulation film thinner than the insulation film in the peripheral edge portion is disposed between the metal plates.

The following describes embodiments of the motor core according to the present disclosure including a first embodiment where no insulation film is disposed between the metal plates in the center portion of the laminated body, and a second embodiment where an insulation film thinner than that in the peripheral edge portion is disposed between the metal plates in the center portion of the laminated body. Note that the “metal thin plate” in the following descriptions of the first embodiment and the second embodiment is a thin plate corresponding to one aspect of the metal plate according to each embodiment.

### I. First Embodiment

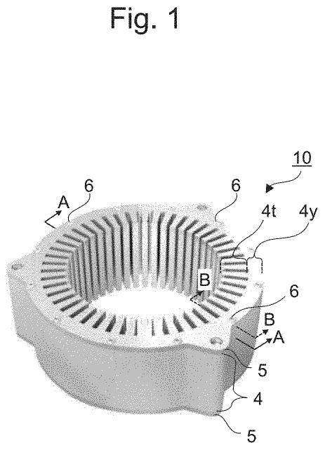

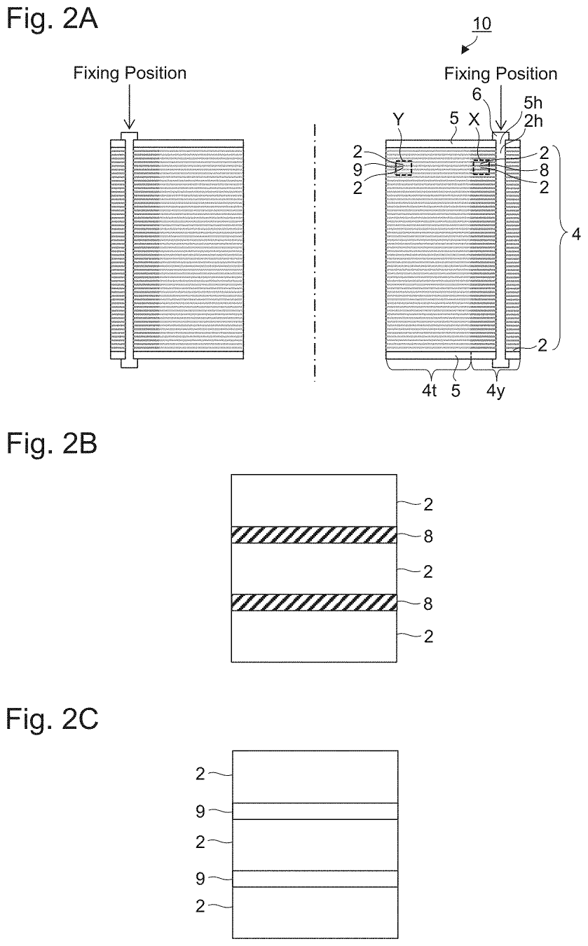

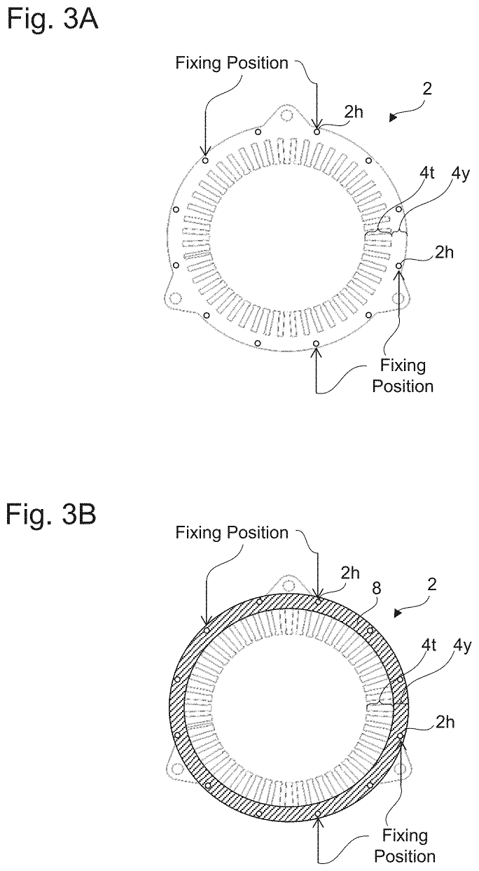

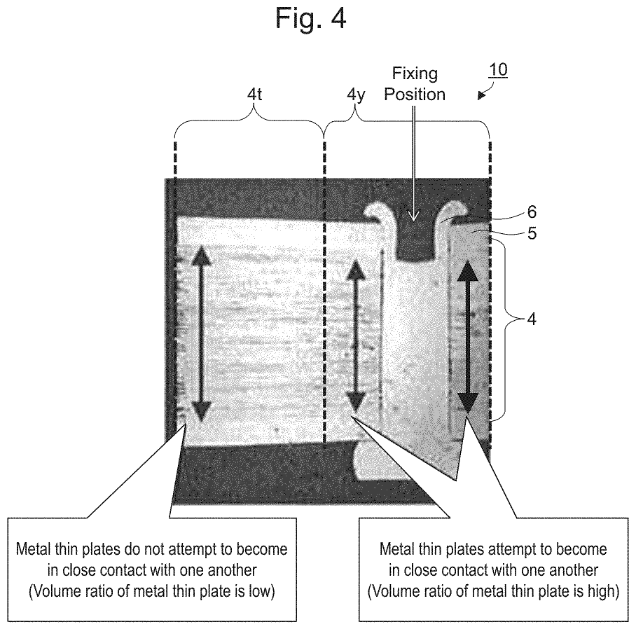

First, an outline of the motor core according to the first embodiment will be described with the exemplifying drawings. Here, FIG. 1 is a schematic perspective view illustrating the exemplary motor core according to the first embodiment. FIG. 2A is a schematic cross-sectional view illustrating a cross section taken along the line A-A of FIG. 1, FIG. 2B is an enlarged view of a pail X of FIG. 2A, and FIG. 2C is an enlarged view of a part Y of FIG. 2A. FIG. 3A is a schematic plan view illustrating the metal thin plate illustrated in FIGS. 2A to 2C, and FIG. 3B is a schematic plan view illustrating the metal thin plate and the insulation film illustrated in FIGS. 2A to 2C. FIG. 4 is a photograph indicating an exemplary cross section taken along the line B-B of FIG. 1.

As illustrated in FIG. 1 and FIG. 2A, a motor core 10 according to the first embodiment is a stator core that includes a laminated body 4, a pair of end plates 5, and rivets 6. A plurality of metal thin plates (one aspect of the metal plate) 2 are laminated in the laminated body 4. The pair of end plates 5 sandwich the laminated body 4 in its lamination direction. The rivets 6 fasten the plurality of metal thin plates 2 one another together with the end plates 5 at fixing positions in a peripheral edge side of the laminated body 4. The laminated body 4 has a structure including a circular back yoke portion 4y (peripheral edge portion) in the peripheral edge side and a teeth portion 4t (center portion) projecting from this back yoke portion 4y toward the center side.

As illustrated in FIG. 2A and FIG. 3A, the plurality of metal thin plates 2 are each provided with fixing holes 2h passing through fixing positions in the peripheral edge side included in the back yoke portion 4y. The end plates 5 are also provided with similar plate fixing holes 5h passing through the fixing positions in the peripheral edge side. The rivets 6 pass through the fixing holes 2h of the plurality of metal thin plates 2 and the plate fixing holes 5h of the end plates 5 to fasten the metal thin plates 2 and the end plates 5.

As illustrated in FIG. 2A to FIG. 2C and FIG. 3B, in the back yoke portion 4y, insulation films 8 are disposed between the metal thin plates 2. In the teeth portion 4t, no insulation film is disposed between the metal thin plates 2.

As illustrated in FIG. 4, in the back yoke portion 4y, since a pressure in the lamination direction to fasten the plurality of metal thin plates 2 to each other with the rivets 6 is large compared with that in the teeth portion 4t, intervals between the metal thin plates 2 illustrated in FIG. 2A are narrowed, and the metal thin plates 2 attempt to become in close contact with one another. However, as illustrated in FIG. 2A, FIG. 2B, and FIG. 3B, the insulation between the metal thin plates 2 can be sufficiently ensured with the insulation films 8 disposed between the metal thin plates 2. In contrast, as illustrated in FIG. 4, in the teeth portion 4t, since the above-described pressure in the lamination direction is small, the metal thin plates 2 does not attempt to become in close contact with one another. Therefore, as illustrated in FIG. 2A, FIG. 2C, and FIG. 3B, while the insulation films 8 are not disposed between the metal thin plates 2, the insulation between the metal thin plates 2 can be sufficiently ensured with voids 9 generated between the metal thin plates 2 depending on the aspect of the motor core 10.

Therefore, according to the first embodiment, the insulation between the metal plates in the laminated body can be sufficiently ensured with the insulation film disposed between the metal plates in the peripheral edge portion compared with the motor core where no insulation film is disposed between the metal plates in the laminated body, thus the eddy-current loss can be reduced. At the same time, compared with the motor core where the insulation film is disposed between the metal plates in the center portion of the laminated body, the intervals between the metal plates in the center portion of the laminated body decreases due to the lack of the insulation films, thus the space factor can be improved. Accordingly, the reduction of the eddy-current loss and the improvement of the space factor can be ensured at the same time. Furthermore, a material cost of the insulation film can be reduced due to the lack of the insulation film between the metal plates in the center portion of the laminated body.

Next, the components of the motor core according to the first embodiment will be each described in detail.

### 1. Laminated Body

The laminated body includes a plurality of laminated metal plates. The plurality of metal plates are fixed to each other with fixing members at fixing positions in the peripheral edge side of the laminated body. In the peripheral edge portion of the laminated body including the fixing positions, the insulation films are disposed between the metal plates. At the center portion of the laminated body, no insulation film is disposed between the metal plates.

The fixing positions are, specifically, positions in the peripheral edge side where the plurality of metal plates are fixed to each other with the fixing members in plan view of the laminated body viewed in the lamination direction. The fixing positions are different depending on the type and the like of the motor core, and in the case of the stator core, for example, the fixing positions may be at a proximity of the center in a radial direction in the back yoke portion of the laminated body.

The peripheral edge portion is, specifically, a circular portion including the fixing positions in plan view of the laminated body viewed in the lamination direction. The peripheral edge portion is different depending on the type of the motor core, and in the case of the stator core, for example, the peripheral edge portion is the back yoke portion as illustrated in FIG. 1. While the peripheral edge portion may extend to the peripheral edge as the back yoke portion illustrated in FIG. 1, the peripheral edge portion does not need to extend to the peripheral edge. A width of the peripheral edge portion is not specifically limited but different depending on the type and the like of the motor core. In the case of the stator core, for example, the width of the peripheral edge portion is in a range of around ⅓ to ½ of an outer diameter.

The center portion is, specifically, a portion in the center side with respect to the fixing positions in plan view of the laminated body viewed in the lamination direction. The center portion is different depending on the type and the like of the motor core, and in the case of the stator core, for example, the center portion is the teeth portion as illustrated in FIG. 1.

### (1) Insulation Film

The insulation film is disposed between the metal plates in the peripheral edge portion and no insulation film is disposed between the metal plates in the center portion.

Here, in the present disclosure, the “insulation film” means an insulation film actively formed between the metal plates after manufacture of the metal plates. In view of this, the insulation film does not include, for example, an oxide film and the like inevitably formed on the metal plate surface during the manufacturing process and the like of the metal plate.

In some embodiments, the insulation film is disposed in the whole peripheral edge portion as the insulation film 8 illustrated in FIGS. 2A to 2C. This is because the insulation between the metal plates can be more effectively ensured. The insulation film may be disposed in a part of the peripheral edge portion. This is because the material cost of the insulation film can be more effectively reduced.

The material of the insulation film is not specifically limited insofar as a desired insulation property is obtained, and may be any of an inorganic material, an organic material, or a composite material of the organic and the inorganic materials. For example, the inorganic material includes SiO₂ and the like, and the organic material includes polyimide and the like.

A method for forming the insulation film is not specifically limited but a general method is applicable, and for example, an application method, a sputtering method, an evaporation method, and the like are included.

The insulation films disposed between the metal plates in the peripheral edge portion have an average film thickness that differs depending on the material and the like of the insulation film in the case of the inorganic material such as SiO₂, for example, the average film thickness is in a range of 0.1 μm to 0.5 μm, and may be in a range of 0.1 μm to 0.3 μm or in a range of 0.1 μm to 0.2 μm in some embodiments. In the case of the organic material such as polyimide, for example, the average film thickness is in a range of 0.1 μm to 0.5 μm, and may be in a range of 0.1 μm to 0.3 μm or in a range of 0.1 μm to 0.2 μm in some embodiments. This is because the excessively thick insulation film possibly has difficulty in improving the space factor and the excessively thin insulation film possibly fails to sufficiently ensure the insulation between the metal plates.

Here, in the present disclosure, the “average film thickness of the insulation film” means an average film thickness obtained by, for example, measuring the film thickness of the insulation film in a state where the insulation film is not applied with the pressure. In addition, the “average film thickness of the insulation film” is obtained by, for example, the measurement with an Auger Electron Spectroscopy (AES), a Transmission Electron Microscope (TEM), and the like.

### (2) Metal Plate

The material of the metal plate is not specifically limited, and for example, an electromagnetic steel plate (silicon steel plate), an amorphous alloy ribbon, a nanocrystalline alloy ribbon, and the like are included. Here, the “nanocrystalline alloy ribbon” is an alloy ribbon where the amorphous alloy ribbon is crystallized, and the nanocrystalline alloy ribbon provides a desired soft magnetic property by precipitating fine crystal grains without substantially causing compound phase precipitation and coarse crystal grains.

The material of the metal plate may be especially the amorphous alloy ribbon, the nanocrystalline alloy ribbon, or the like. Since the thickness is decreased to approximately 1/10 compared with that of the electromagnetic steel plate, in the case of the amorphous alloy ribbon or the nanocrystalline alloy ribbon, it is necessary to laminate about ten times as many metal plates as in the case of the electromagnetic steel plate for obtaining the laminated body approximately same in thickness. Consequently, increases of a proportion of a volume occupied by the insulation film in the laminated body causes a significant influence of the decrease of the space factor. Accordingly, the effect of improvement in the space factor becomes remarkable.

The thickness of the metal plate is not specifically limited, but different depending on the material and the like of the metal plate. In the case of the electromagnetic steel plate, the thickness is, for example, approximately 0.25 mm. In the case of the amorphous alloy ribbon or the nanocrystalline alloy ribbon, the thickness is, for example, approximately 0.025 mm.

The shape of the metal plate is not specifically limited, and for example, a shape of an alloy plate used for a stator core and/or a rotor core is included. When the fixing member passes through the metal plate, as illustrated in FIG. 2A and FIG. 3A, the metal plate is provided with fixing holes through which the fixing member passes.

### (3) Number of Lamination in Laminated Body and the Like

The number of lamination of the metal plates in the laminated body is not specifically limited, hut allowed to be appropriately determined depending on the material and the like of the metal plate so as to obtain a desired torque of the motor. The thickness of the laminated body is not specifically limited, but allowed to be appropriately determined depending on the material and the like of the metal plate so as to obtain the desired torque.

### 2. Fixing Member

The fixing member fixes the plurality of metal plates to each other at the fixing position. The fixing member is not specifically limited to insofar as the fixing member is used in an aspect where the laminated body is applied with the pressure in the lamination direction at the fixing position, but a fixing member commonly used in the laminated body can be used. For example, the rivet as illustrated in FIG. 1 and a bolt and nut are included.

### 3. Motor Core

The motor core is not specifically limited but a commonly used motor core can be used. For example, the stator core as illustrated in FIG. 1 and a rotor core are included.

The motor core may include, for example, as illustrated in FIG. 1, the pair of end plates that sandwich the laminated body in the lamination direction. As the end plate, for example, an end plate commonly used in the motor core can be used. When the fixing member passes through the end plate, as illustrated in FIG. 2A, the end plate is provided with plate fixing holes through which the fixing member passes.

While the motor core may be, for example, a motor core where a plurality of metal plates are fixed to each other with a fixing member via another member such as the end plate, as the motor core 10 illustrated in FIG. 1 where the plurality of metal thin plates 2 are fastened to each other with the rivets 6 via the pair of end plates 5, the motor core may be a motor core where a plurality of metal plates are directly fixed with a fixing member without another member such as the end plate.

Since the insulation film is not disposed between the metal plates in the center portion in the first embodiment, the intervals between the metal plates in the center portion are more narrowed compared with those of the second embodiment. This ensures more significantly improved space factor, and further, more effectively reduced material cost.

### II. Second Embodiment

The following mainly describes differences between the second embodiment and the first embodiment.

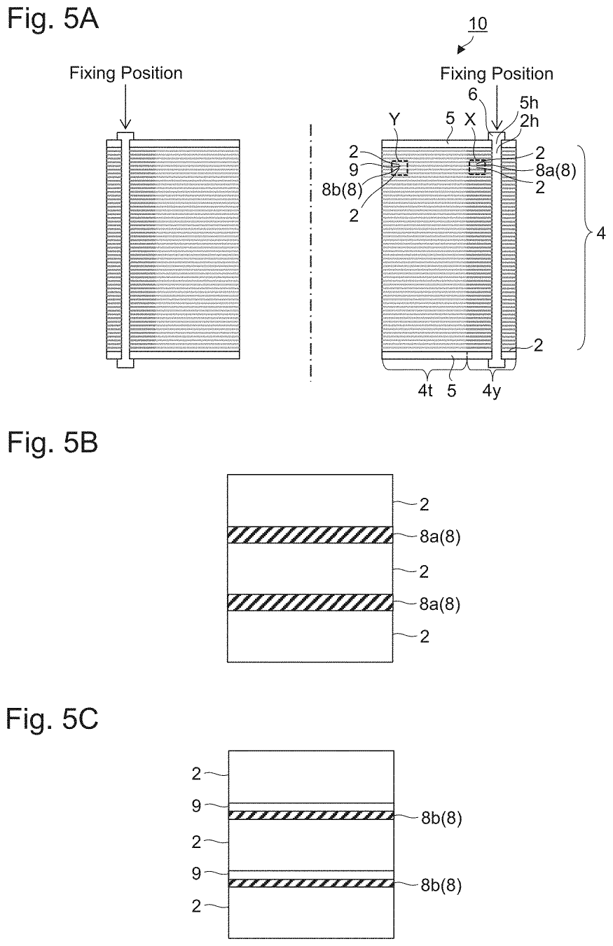

First, an outline of the motor core according to the second embodiment will be described with the exemplifying drawings. Here, FIG. 5A is a schematic cross-sectional view illustrating an exemplary motor core according to the second embodiment, and a schematic cross-sectional view corresponding to FIG. 2A. FIG. 5B is an enlarged view of a part X of FIG. 5A, and. FIG. 5C is an enlarged view of a part Y of FIG. 5A.

As illustrated in FIG. 5A to FIG. 5C, a motor core 10 according to the second embodiment includes insulation films 8a between metal thin plates (one aspect of the metal plate) 2 in a back yoke portion 4y (peripheral edge portion), and insulation films 8b thinner than those in the back yoke portion 4y between the metal thin plates 2 in a teeth portion 4t (center portion). Accordingly, while, since the pressure in the lamination direction to fasten the plurality of metal thin plates 2 to each other with the rivets 6 is large in the back yoke portion 4y, the metal thin plates 2 attempt to become in close contact with one another in the back yoke portion 4y, the insulation between the metal thin plates 2 can be sufficiently ensured with the insulation films 8a. In contrast, since the above-described pressure in the lamination direction is small in the teeth portion 4t, the metal thin plates 2 do not attempt to become in close contact with one another. Accordingly, the insulation between the metal thin plates 2 can be sufficiently ensured with voids 9 generated between the metal thin plates 2 and the insulation films 8b depending on the aspect of the motor core 10 regardless of the insulation films 8b between the metal thin plates 2 thinner than those in the back yoke portion 4y.

Therefore, according to the second embodiment, the insulation between the metal plates in the laminated body can be sufficiently ensured with the insulation film disposed between the metal plates in the peripheral edge portion and the center portion compared with the motor core where no insulation film is disposed between the metal plates in the laminated body, thus the eddy-current loss can be reduced. At the same time, compared with the motor core where the insulation film having the film thickness as same as that in the peripheral edge portion is disposed between the metal plates in the center portion of the laminated body, the intervals between the metal plates in the center portion of the laminated body decreases due to the reduction in thickness of the thin insulation film, thus the space factor can be improved. Accordingly, the reduction of the eddy-current loss and the improvement of the space factor can be ensured at the same time. Furthermore, a material cost of the insulation film can be reduced by the reduction in thickness of the thin insulation film between the metal plates in the center portion of the laminated body.

Next, the components of the motor core according to the second embodiment will be each described in detail mainly on the difference from the first embodiment.

The motor core according to the second embodiment includes, different from the first embodiment, the insulation film which is thinner than those in the peripheral edge portion, in the center portion of the laminated body, between the metal plates. Here, in the present disclosure, the “insulation film thinner than that in the peripheral edge portion” specifically means an insulation film having an average film thickness thinner than that of the insulation films disposed between the metal plates in the peripheral edge portion.

The average film thickness of the insulation film disposed between the metal plates in the center portion differs depending on the material and the like of the insulation film. In the case of the inorganic material such as SiO₂, for example, the average film thickness is in a range of 0.5 μm or less, and may be in a range of 0.3 μm or less or in a range of 0.2 μm or less in some embodiments. In the case of the organic material such as polyimide, for example, the average film thickness is in a range of 0.5 μm or less, and may be in a range of 0.3 μm or less or in a range of 0.2 μm or less in some embodiments. This is because the excessively thick insulation film possibly has difficulty in improving the space factor.

The insulation film disposed between the metal plates in the peripheral edge portion and the insulation film disposed between the metal plates in the center portion are usually formed of the same material with the same method.

The respective components of the motor core according to the second embodiment are similar to those in the first embodiment except for the components described here. Since the insulation films are disposed between the metal plates in the center portion in the second embodiment, the insulation between the metal plates in the center portion can be more effectively ensured to more significantly reduce the eddy-current loss compared with the first embodiment.

While the embodiments of the motor core according to the present disclosure have been described in detail above, the present disclosure is not limited thereto, and can be subjected to various kinds of changes in design without departing from the spirit and scope of the present disclosure described in the claims.

All publications, patents and patent applications cited in the present description are herein incorporated by reference as they are.

### DESCRIPTION OF SYMBOLS

2 Metal thin plate
4 Laminated body
6 Rivet
8 Insulation film
10 Motor core

What is claimed is:

1. A motor core comprising:
a laminated body where a plurality of metal plates are laminated;
a fixing member that fixes the plurality of metal plates to each other at a fixing position in a peripheral edge side of the laminated body; and
an insulation film disposed between the metal plates in a peripheral edge portion of the laminated body including the fixing position,
wherein in a center portion of the laminated body, no insulation film is disposed between the metal plates, or an insulation film thinner than the insulation film in the peripheral edge portion is disposed between the metal plates.
